(19) United States
(12) Patent Application Publication
(10) Pub. No.: US 2009/0309958 A1
(43) Pub. Date: Dec. 17, 2009

(54) DISPLAY DEVICE

(75) Inventors: Goro HAMAGISHI, Toyonaka-shi (JP); Nobuo SUGIYAMA, Suwa-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/477,243

(22) Filed: Jun. 3, 2009

(30) Foreign Application Priority Data
Jun. 16, 2008 (JP) 2008-156280

(51) Int. Cl. H04N 13/04

(52) U.S. Cl. 348/54; 348/E13.001

(57) ABSTRACT

A display device provides first and second images. The display device includes a display panel having electro-optical elements, including a first element group with first-image display elements displaying the first image and a second element group with second-image display elements displaying the second image. A light advance control unit controls light emitted from the first element group to advance to a first area displaying the first image and controls light emitted from the second element group to advance to a different, second area displaying the second image. The first and second element groups are controlled such that a first period in which the first-image display elements are driven and at least a part of the second-image display elements is not driven and a second period in which the second-image display elements are driven and at least a part of the first-image display elements is not driven are repeated.

### BACKGROUND

1. Technical Field

The present invention relates to a display device that supplies a first image to a first area and supplies a second image to a second area.

2. Related Art

Generally, display devices for two-screen display that display a plurality of images on one screen, supply a first image of the plurality of images to a first area, and supply a second image of the plurality of images to a second area have been known (for example, see JP-A-2005-258016). For example, by disposing such a display device for two-screen display between a driver's seat and a front passenger seat within a vehicle, a person on the driver's seat can watch, for example, a video of a car navigation device, and a person on the front passenger seat can watch other videos.

In a display panel of the above-described display devices, a plurality of electro-optical elements that is disposed in correspondence with intersections of a plurality of scanning lines and a plurality of data lines is disposed. In the plurality of electro-optical elements, a plurality of first-image display elements for displaying a first image and a plurality of second-image display elements for displaying a second image are included. In addition, the first-image display element and the second-image display element are commonly connected to each of the plurality of scanning lines.

When one scanning line is selected from among the plurality of scanning lines, to the first-image display element and the second-image display element that are connected to the scanning line, data electric potentials are simultaneously supplied. At this moment, the data electric potential supplied to the first-image display element is changed by the influence of the data electric potential supplied to the second-image display element, and the data electric potential supplied to the second-image display element is changed by the influence of the data electric potential supplied to the first-image display element. Accordingly, image display of both the first and second-image display elements become unstable, and thus, a problem of crosstalk occurs.

### SUMMARY

An advantage of some aspects of the invention is that it provides a display device, which supplies a first image to a first area and supplies a second image to a second area, capable of suppressing deterioration of display quality.

According to a first aspect of the invention, there is provided a display device that provides a first image and a second image. The display device includes a display panel including a plurality of electro-optical elements that is disposed in correspondence with intersections of a plurality of scanning lines and a plurality of data lines and includes a first element group that is formed of a plurality of first-image display elements displaying the first image and a second element group formed of a plurality of second-image display elements displaying the second image; a light advance control unit that controls light emitted from the first element group in the display panel to advance to a first area displaying the first image and controls light emitted from the second element group to advance to a second area, which is different from the first area, displaying the second image; and a control unit that drives the first element group and the second element group. The first-image display element and the second-image display element are commonly connected to each of the plurality of scanning lines, and the control unit controls driving of the first element group and the second element group such that a first period in which the first-image display elements of the first element group are driven and at least a part of the second-image display elements of the second element group is not driven and a second period in which the second-image display elements of the second element group are driven and at least a part of the first-image display elements of the first element group is not driven are repeated.

According to the above-described display device, in the first period, the first-image display elements of the first element group are driven and at least a part of the second-image display elements of the second element group is not driven. In addition, in the second period, the second-image display elements of the second element group are driven and at least a part of the first-image display elements of the first element group is not driven are repeated. Accordingly, unstable display of the first image and the second image can be suppressed, compared to a configuration in which the first-image display elements and the second-image display elements are simultaneously driven. As a result, there is an advantage that deterioration of display quality of the display device can be suppressed.

Here, the “electro-optical element” is an element of which optical characteristics such as light emitting characteristics or optical transmittance characteristics change in accordance with applied electrical energy. As an element of which light emitting characteristics change in accordance with applied electrical energy, for example, there is an organic EL (electroluminescent) element, or an organic light emitting diode element that is referred to as a light emitting polymer element (hereinafter, referred to as an “OLED”) or the like. In addition, as an element of which optical transmittance characteristics change in accordance with applied electrical energy, for example, there is a liquid crystal.

In the above-described display device, it is preferable that the first period and the second period are repeated at a frequency of 60 Hz or higher. In such a case, there is an advantage that generation of flicker in the display device can be suppressed. Here, the “flicker” represents a phenomenon that blinking of an image can be recognized in the human eyes due to low refresh rate that is a low frequency of image rewriting.

In addition, in the above-described display device, it may be configured that the first image is incident to an observer's right eye, the second image is incident to an observer's left eye, and the observer recognizes a stereoscopic image due to parallax of the first image and the second image.

In addition, in the above-described display device, it may be configured that a distance between first area and the second area is longer than a distance between the observer's two eyes, and a first observer is located in the first area, and a second observer is located in the second area.

Furthermore, in the above-described display device, in the first period, all the second-image display elements of the second element group may be configured not to be driven, and, in the second period, all the first-image display elements of the first element group may be configured not to be driven.

### BRIEF DESCRIPTION OF THE DRAWINGS

The invention will be described with reference to the accompanying drawings, wherein like numbers reference like elements

FIG. 1 is a cross-section view of a display device according to an embodiment of the invention.

FIG. 2 is a block diagram showing the electrical configuration of a display panel according to an embodiment of the invention.

FIG. 3 is a schematic diagram of a display device according to an embodiment of the invention.

FIG. 4 is a timing chart showing the operation of a display device according to an embodiment of the invention.

FIGS. 5A and 5B are schematic diagrams showing display contents in a first-image display period and a second-image display period according to an embodiment of the invention.

FIGS. 6A and 6B are schematic diagrams showing a first image output to a first observation area and a second image output to a second observation area according to an embodiment of the invention.

FIG. 7 is a diagram showing a configuration in which a first-image display period and a second-image display period are repeated.

FIG. 8 is a schematic diagram of a display device according to a modified example of the invention.

FIG. 9 is a block diagram showing the electrical configuration of a display panel according to a modified example of the invention.

FIGS. 10A and 10B are schematic diagrams showing the display content in a first-image display period and a second-image display period.

### DESCRIPTION OF EXEMPLARY EMBODIMENTS

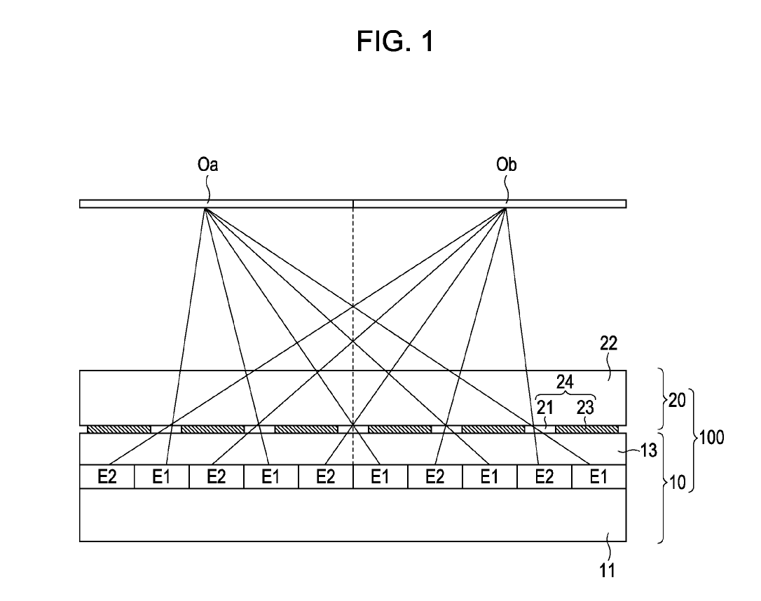

FIG. 1 is a cross-section view of a display device 100 according to an embodiment of the invention. The display device 100 according to this embodiment is disposed between a driver's seat and a front passenger seat inside a vehicle In a first area Oa shown in FIG. 1, a driver is located, and in a second area Ob shown in FIG. 1, a passenger on a front passenger seat is located.

As shown in FIG. 1, the display device 100 includes a display panel 10 and a light advance control unit 20. The display panel 10 includes a first substrate 11, electro-optical elements E (E1 and E2) that is formed on the first substrate 11, and a protection layer 13 that covers the electro-optical element E. The protection layer 13 is used for preventing penetration of moisture or gas into the electro-optical elements E. The protection layer 13 is formed of a silicon compound such as a silicon nitride or silicon oxide that is formed by using a high-density plasma film forming method.

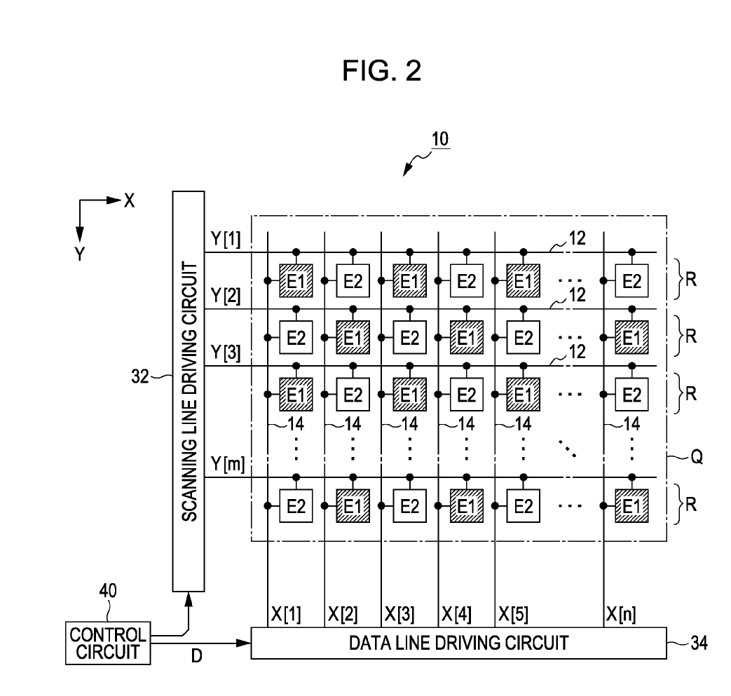

FIG. 2 is a block diagram showing the electrical configuration of the display panel 10. As shown in FIG. 2, the display panel 10 includes a component unit Q in which a plurality of electro-optical elements E is arranged in a plate shape. Each of the plurality of the electro-optical elements E is an OLED element that is formed by interposing an organic EL light emitting layer between electrodes (an anode and a cathode) opposing each other. The gray scales of the plurality of electro-optical elements are changed in accordance with applied voltages.

Inside the component unit Q, m scanning lines 12 that extends in direction X and n data lines 14 that extends in direction Y that interesting direction X are disposed (here, m and n are natural numbers). The plurality of electro-optical elements E is disposed in correspondence with intersections of the plurality of scanning lines 12 and the plurality of data lines 14. As shown in FIG. 2, inside the component unit Q, a plurality of element rows R each configured by n electro-optical elements E connected to each scanning line 12 is disposed in parallel with direction Y.

As shown in FIG. 2, the plurality of electro-optical elements E is divided into first-image display elements E1 that are used for displaying a first image GA and a second-image display element E2 that is used for displaying a second image GB. According to this embodiment, a first element group that is configured by a plurality of the first-image display elements E1 and a second element group that is configured by a plurality of the second-image display elements E2 are disposed in the display panel 10.

As shown in FIG. 2, the first-image display elements E1 and the second-image display elements E2 are arranged alternately in directions X and Y. According to this embodiment, electro-optical elements E of odd columns in each odd element row R and electro-optical elements E of even columns in each even element row R are the first-image display elements E1. In addition, electro-optical elements E of even columns in each odd element row R and electron optical elements E of odd columns in each even element row R are the second-image display elements E2. In FIG. 2, when focused on one scanning line 12, to one scanning line 12, a plurality of (n/2) the first-image display elements E1 and a plurality of (n/2) of the second-image display elements E2 are commonly connected. In addition, in one scanning line 12, the first-image display elements E1 and the second-image display elements E2 are disposed alternately along the direction X.

The light advance control unit 20 shown in FIG. 1 is a parallax barrier. The light advance control unit 20 controls light emitted from the first-image display elements E1 (the first element group) in the display panel 10 to advance to the first area Oa and controls light emitted from the second-image display elements E2 (the second element group) in the display panel 10 to advance to the second area Ob. As shown in FIG. 1, the light advance control unit 20 includes a second substrate 22 that is formed of a transparent body such as glass and a barrier layer 24 that is formed on the second substrate 22.

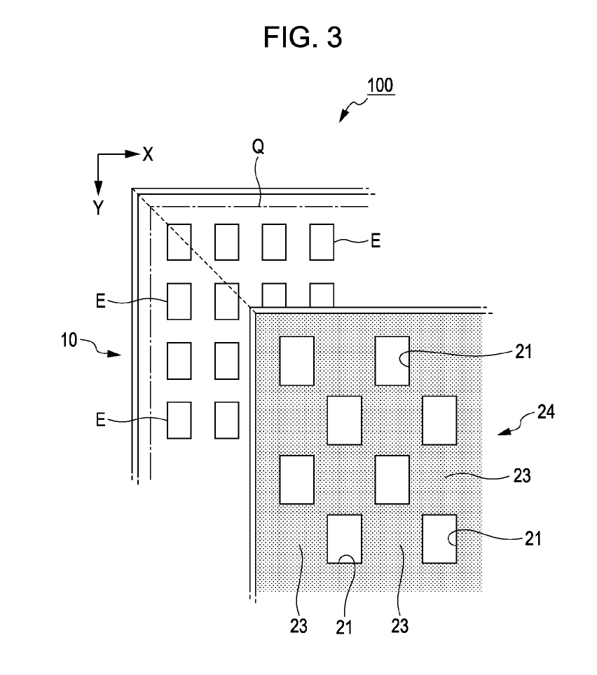

As shown in FIG. 3, in the barrier layer 24, opening parts 21 and light shielding parts 23 are formed. The opening parts 21 and the light shielding parts 23 are disposed alternately along directions X and Y. In addition, as shown in FIG. 1, display light emitted by the first-image display element E1 passes through each opening parts 21 of the barrier layer 24 so as to reach the first area Oa, and display light emitted by the second-image display element E2 passes through each opening part 21 of the barrier layer 24 so as to reach the second area Ob. In the first area, a first image is displayed by the first-image display elements E1, and in the second area, a second image is displayed by the second-image display elements E2.

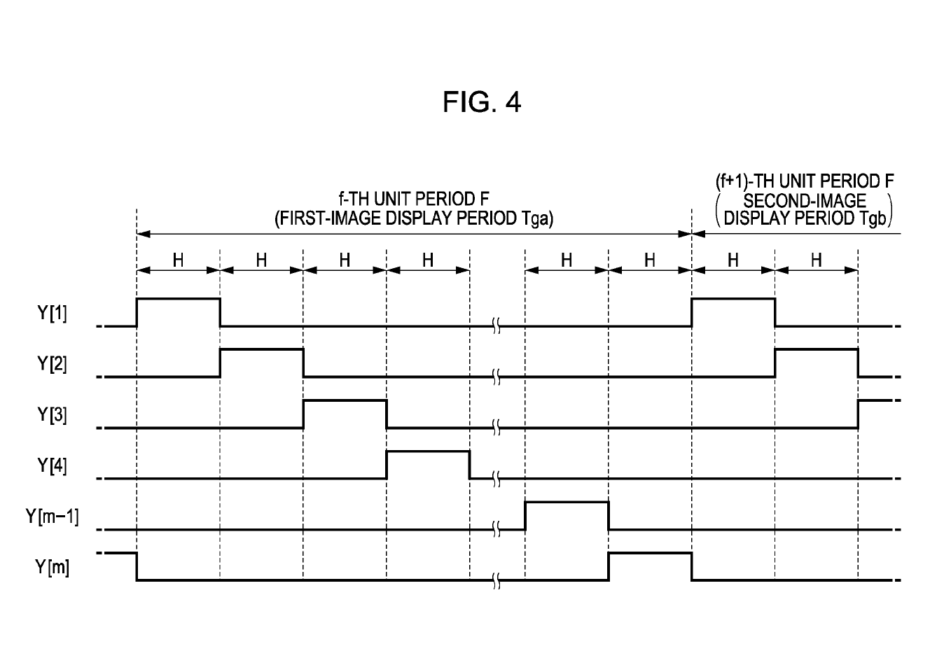

FIG. 4 is a timing chart showing the operation of the display device 100 according to this embodiment. The scanning line driving circuit 32 shown in FIG. 2 sequentially selects m scanning lines 12 for each horizontal scanning period H within each unit period (vertical scanning period) F by sequentially setting the scanning signals Y (Y[1] to Y[m]) output to the scanning lines 12 to an active level in a predetermined order, as shown in FIG. 4.

The data line driving circuit 34 shown in FIG. 2 generates data electric potentials X (X[1] to X[n]) corresponding to n electro-optical elements E of one row connected to the scanning line 12 selected by the scanning line driving circuit 32 and outputs the data electric potentials to the data lines 104. When an i-th row (here, i is an integer satisfying the condition of 1≦i≦m) is selected, the data electric potential X[j] that is output to the data line 104 of a j-th column (here, j is an integer satisfying the condition of 1≦j≦n) becomes an electric potential corresponding to a gray scale designated to the electro-optical element E located in the j-th column of the i-th row.

The control unit 40 shown in FIG. 2, controls driving of the first element group and the second element group that are disposed on the display panel 10. The control unit 40, for example, outputs the gray scale data D to the data line driving circuit 34 along with outputting, for example, a synchronization signal or the control signal to the scanning line driving circuit 32 and the data line driving circuit 34. The gray scale data D is data for designating the gray scales of each element E in the first image GA and the second image GB The data line driving circuit 34 generates data electric potentials X to be output to the data lines 14 based on the gray scale data D that is supplied from the control unit 40.

According to this embodiment, the control unit 40 controls driving of the first element group and the second element group such that a first period in which the first-image display element E1 of the first element group are driven and the second-image display elements E2 of the second element group are not driven and a second period in which the second-image display elements E2 of the second element group are driven and the first-image display elements E1 of the first element group are not driven are repeated. A more detailed description will be followed.

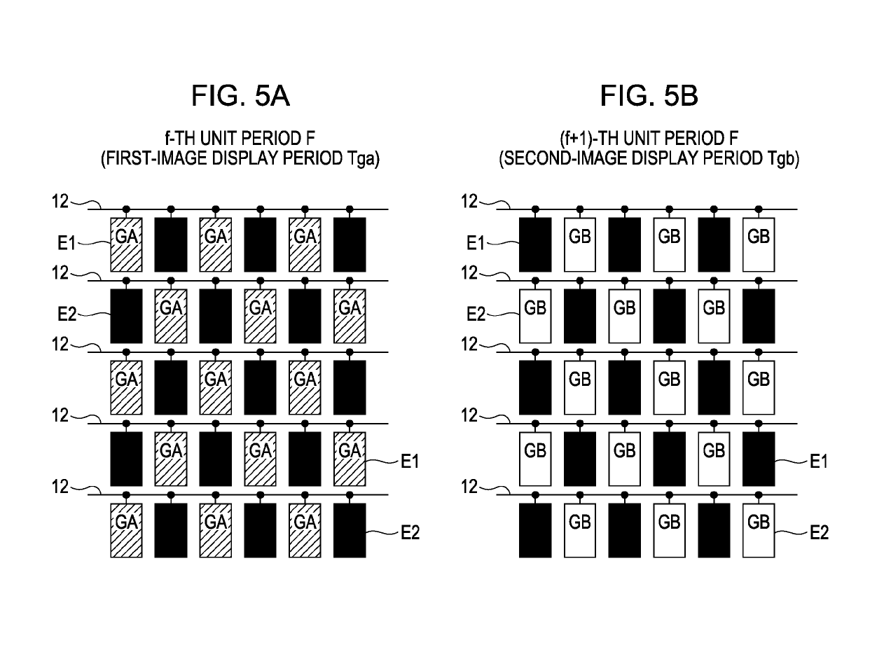

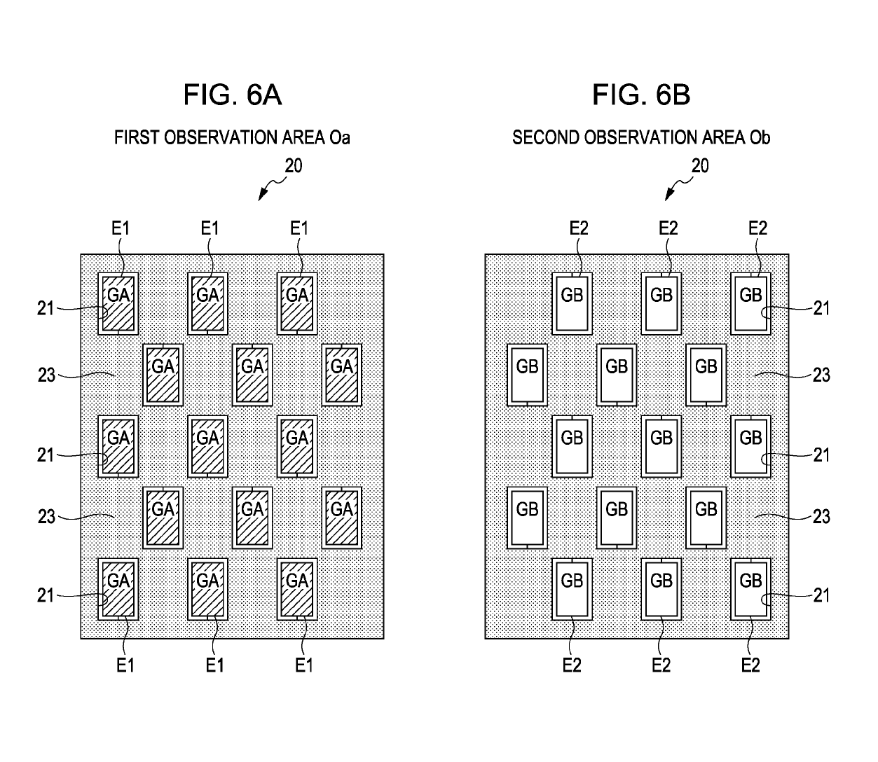

The control unit 40, as shown in FIG. 5A, controls the data line driving circuit 34 such that only the first images GA are displayed and the second images GB are displayed in black in an f-th (here, f is an odd number) unit period F (hereinafter, referred to as a “first-image display period Tga”). At this moment, to the driver located in the first area Oa, the first images GA shown in FIG. 6A are output.

Here, the data electric potential X supplied to the electro-optical element E becomes an electrical potential in accordance with a gray scale designated to the electro-optical element E. In this embodiment, when the “black” that is the lowest gray scale is designated, the value of the data electric potential X is “0” V. In other words, in the first-image display period Tga, the data line driving circuit 34 supplies the data electric potentials X for displaying the first images GA to the first-image display elements E1 and does not supply the data electric potential X to the second-image display elements E2 Accordingly, in the first-image display period Tga, the second-image display elements E2 are not driven. Thus, unstable display (generation of crosstalk) of the first images GA due to influence of the data electric potentials X supplied to the second-image display elements E2 on the data electric potential X supplied to the first-image display elements El needed for displaying the first images GA can be suppressed.

On the other hand, the control circuit 40 as the control unit, as shown in FIG. 5B, in the (f+1)-th (that is, even) unit period F (hereinafter, referred to as a “second-image display area Tgb”), controls the data line driving circuit 34 such that only the second images GB are displayed, and the first images GA become a black display. At this moment, to a passenger located on the front passenger seat that is located at the second area Ob, the second images GB shown in FIG. 6B are output.

In addition, in the second-image display period Tgb, the data line driving circuit 34 supplies the data electric potentials X for displaying the second images GA to the second-image display elements E2 and does not supply the data electric potential X to the first-image display element E1. Accordingly, in the second-image display period Tgb, the first-image display elements E1 are not driven. Thus, unstable display (generation of crosstalk) of the second images GB due to influence of the data electric potentials X supplied to the first-image display elements E1 on the data electric potential X supplied to the second-image display elements E2 needed for displaying the second images GB can be suppressed.

In other words, according to this embodiment, in the first-image display period Tga, only the first-image display elements E1 needed for displaying the first images GA are driven, and the second-image display elements E2 are not driven. In addition, in the second-image display period Tgb, only the second-image display elements E2 needed for displaying the second images GB are driven, and the first-image display elements E1 are not driven. Accordingly, compared to a configuration in which the first-image display elements E1 needed for displaying the first images GA and the second-image display elements E2 needed for displaying the second images GB are simultaneously driven is used, unstable display of the first images GA and the second images GB can be suppressed. Accordingly, according to this embodiment, there is an advantage that deterioration of the display quality of the display device 100 can be suppressed.

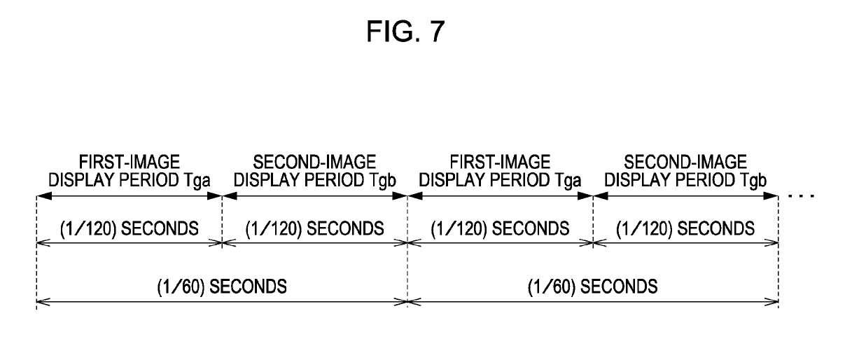

In addition, the control unit 40 according to this embodiment, as shown in FIG. 7, controls the first-image display period Tga and the second-image display period Tgb to be repeated at the frequency of 60 Hz (that is, repeated at the period of 1/60 second). According to such a configuration, there is an advantage that generation of flicker can be suppressed for the first image GA and the second image GB. In addition, the control unit 40 may be configured to control the first-image display period Tga and the second-image display period Tgb to be repeated at a frequency higher than the frequency of 60 Hz.

The invention is not limited to the above-described embodiments, and, for example, changes in forms described below may be made therein. In addition, among the modified examples described below, two or more modified examples may be combined.

### MODIFIED EXAMPLE 1

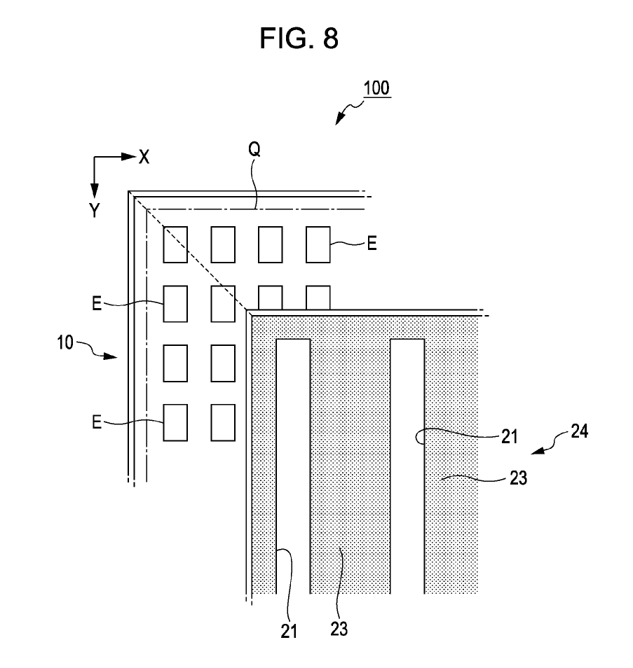

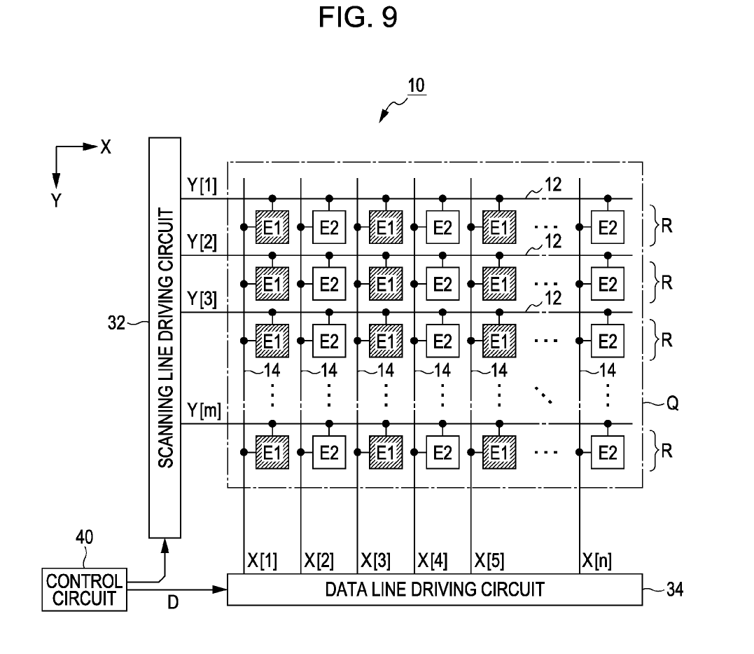

In the barrier layer 24 of the light advance control unit 20 according to the above-described embodiment, as shown in FIG. 3, the opening parts 21 and the light shielding parts 23 are formed so as to be disposed alternately along the directions X and Y. However, as shown in FIG. 8, it may be configured that the opening parts 21 are formed to extend along direction Y and the opening parts 21 and the light shielding parts 23 are formed so as to be disposed alternately along direction X. Under such a configuration, for example, as shown in FIG. 9, the electro-optical elements E of odd columns in each element row R are the first-image display elements E1, and the electro-optical elements E of even columns in each element row R are the second-image display elements E2.

In addition, in the above-described embodiments, the light advance control unit 20 is exemplified as parallax barrier. However, the invention is not limited thereto. Thus, for example, the light advance control unit 20 may be configured by a lenticular lens. Basically, the light advance control unit 20 may be any unit that controls light emitted from the first-image display elements E1 (the first element group) in the display panel 10 to advance to the first area Oa and controls the light emitted from the second-image display elements E2 (the second element group) in the display panel 10 to advance to the second area Ob, and a detailed configuration thereof is arbitrary.

### MODIFIED EXAMPLE 2

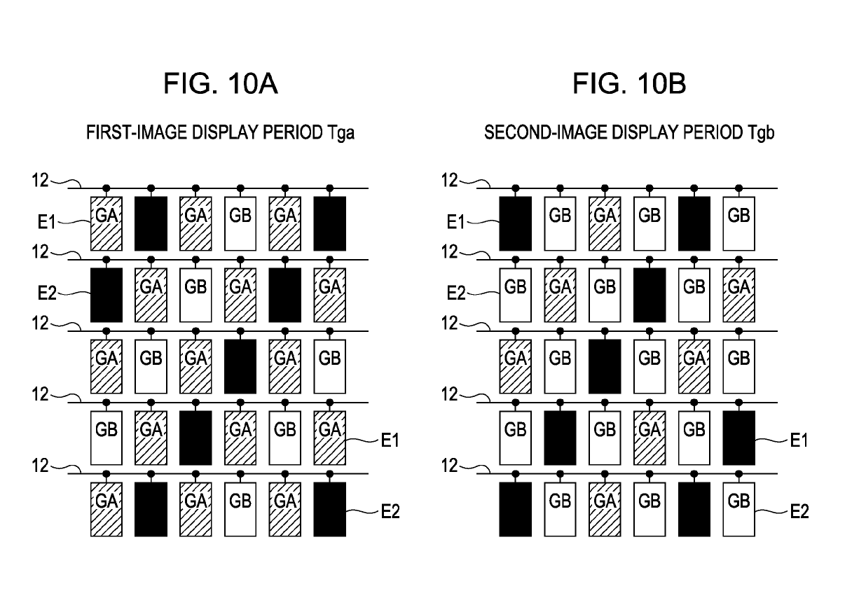

In the above-described embodiments, in the first-image display period Tga, a configuration in which only the first-image display elements E1 needed for displaying the first image GA are driven, and the second-image display elements E2 are not driven has been exemplified. However, the invention is not limited thereto, and for example, a configuration in which, in the first-image display period Tga, as shown in FIG. 10A, the first-image display elements E1 needed for displaying the first-image GA are driven, and a part of the second-image display elements E2 needed for displaying the second image GB is not driven (that is, “black” is designated to the part of the second-image display elements E2) may be used.

In addition, in the above-described embodiments, in the second-image display period Tgb, a configuration in which only the second-image display elements E2 needed for displaying the second image GB are driven, and the first-image display elements E1 are not driven has been exemplified. However, the invention is not limited thereto, and for example, a configuration in which, in the second-image display period Tgb, as shown in FIG. 10B, the second-image display elements E2 needed for displaying the second image GB are driven, and a part of the first-image display elements E1 needed for displaying the first image GA is not driven (that is, “black” is designated to the part of the first-image display elements E1) may be used.

Basically, the control unit 40 according to an embodiment of the invention is configured so as to control driving of the elements such that a first period (corresponding to the above-described first-image display period Tga) in which the first-image display elements E1 needed for displaying the first image GA are driven and at least a part of the second-image display elements E2 needed for displaying the second images GB is not driven and a second period (corresponding to the above-described second-image display period Tgb) in which the second-image display elements E2 needed for displaying the second image GB are driven and at least a part of the first-image display elements E1 needed for displaying the first image GA is not driven are repeated. In such a case, unstable display of the first images GA and the second images GB can be suppressed, compared to a case where the first-image display elements E1 needed for displaying the first image GA and the second-image display elements E2 needed for displaying the second image GB are simultaneously driven. Therefore, there is an advantage that deterioration of the display quality of the display device 100 can be suppressed.

### MODIFIED EXAMPLE 3

For example, a configuration in which the first images GA are incident to an observer's right eye, the second images GB are incident to the observer's left eye, and the observer can recognize a stereoscopic image based on the parallax of the first images GA and the second images GB may be used. In such a case, the first area Oa corresponds to the observer's right eye, and the second area Ob corresponds to the observer's left eye.

In addition, same as in the above-described embodiments, a configuration in which a distance between the first area Oa and the second area Ob is longer than a distance between observer's two eyes, a first observer recognizing the first image GA is located in the first area Oa, and a second observer recognizing the second image GB is located in the second area Ob may be used. The purpose of a display device (the display device for two screen display) having such a configuration is arbitrary. Thus, for example, the display device may be used for a business meeting, commercial display, or a home television set. In addition, the display device may be used in a two-screen battle-type television game or the like.

### MODIFIED EXAMPLE 4

In the above-described embodiments, the display device 100 for two screen display has been exemplified. However, the invention is not limited thereto. Thus, a display device according to an embodiment of the invention may be a display device for displaying three or more images on one screen.

For example, for the case of a display device for three-screen display that supplies a first image to a first area, supplies a second image to a second area, and supplies a third image to a third area, a plurality of electro-optical elements E disposed on the display panel 10 is configured by a plurality of first-image display elements for displaying the first image, a plurality of second-image display elements for displaying the second image, and a plurality of third image display elements for displaying the third image. To each of the plurality of scanning lines 12, the first-image display element, the second-image display element, and the third image display element are commonly connected.

Then, in the (3k+1)-th (here, k=0, 1, 2 . . . ) unit period (vertical scanning period) F, only the first-image display elements needed for displaying the first image are driven, and the second-image display elements and the third image display elements are not driven. In addition, in the (3k+2)-th unit period F, only the second-image display elements E2 needed for displaying the second image are driven, and the first-image display elements and the third image display elements are not driven. In the (k+3)-th unit period F, only the third image display elements needed for displaying the third image are driven, and the first-image display elements and the second-image display elements are not driven.

In the above-described configuration, driving of the elements is controlled by the control unit such that a first period (in the above-described configuration, the (k+1)-th unit period F) in which the first-image display elements needed for displaying the first image are driven and the second-image display elements are not driven and a second period (in the above-described configuration, the (k+2)-th unit period F) in which the second-image display elements needed for displaying the second image are driven and the first-image display elements are not driven are repeated with a third period (in the above-described configuration, the (k+3)-th unit period F) in which the first-image display elements and the second-image display elements are not driven interposed therebetween. Accordingly, unstable display of the images can be suppressed, compared to a case where, in each unit period F, the first-image display elements needed for displaying the first image, the second-image display elements needed for displaying the second image, and the third image display elements needed for displaying the third image are simultaneously driven.

### MODIFIED EXAMPLE 5

In the above-described embodiments, the electro-optical elements E configured by OLED elements have been exemplified. However, the invention is not limited thereto. Thus, for example, the electro-optical element E may be configured by liquid crystal elements formed by interposing a liquid crystal between the electrodes (the pixel electrode and the opposing electrode) facing each other. Basically, the electro-optical element E is an element of which optical characteristics such as light emitting characteristics or optical transmittance changes in accordance with applied electrical energy may be used.

The entire disclosure of Japanese Patent Application No. 2008-156280, filed Jun. 16, 2008 is expressly incorporated by reference herein.

What is claimed is:

1. A display device that provides a first image and a second image, the display device comprising:
a display panel including a plurality of electro-optical elements that is disposed in correspondence with intersections of a plurality of scanning lines and a plurality of data lines and includes a first element group that is formed of a plurality of first-image display elements displaying the first image and a second element group formed of a plurality of second-image display elements displaying the second image;
a light advance control unit that controls light emitted from the first element group in the display panel to advance to a first area displaying the first image and controls light emitted from the second element group to advance to a second area, which is different from the first area, displaying the second image; and
a control unit that drives the first element group and the second element group,
wherein the first-image display element and the second-image display element are commonly connected to each of the plurality of scanning lines, and
wherein the control unit controls driving of the first element group and the second element group such that a first period in which the first-image display elements of the first element group are driven and at least a part of the second-image display elements of the second element group is not driven and a second period in which the second-image display elements of the second element group are driven and at least a part of the first-image display elements of the first element group is not driven are repeated.

2. The display device according to claim 1, wherein the first period and the second period are repeated at a frequency of 60 Hz or higher.

3. The display device according to claim 1,
wherein the first image is incident to an observer's right eye, and the second image is incident to an observer's left eye, and
wherein the observer recognizes a stereoscopic image due to parallax of the first image and the second image.

4. The display device according to claim 1,
wherein a distance between first area and the second area is longer than a distance between the observer's two eyes, and
wherein a first observer is located in the first area, and a second observer is located in the second area.

5. The display device according to claim 1,
wherein, in the first period, all the second-image display elements of the second element group are not driven, and
wherein, in the second period, all the first-image display elements of the first element group are not driven.
